(19) United States
(12) Patent Application Publication
(10) Pub. No.: US 2025/0034058 A1
(43) Pub. Date: Jan. 30, 2025

(54) BINDER-FREE NANOPARTICLE COATING FOR INORGANIC FERTILIZERS

(71) Applicants: EUROCHEM ANTWERPEN, Antwerpen (BE); UNIVERSITEIT ANTWERPEN, Antwerpen (BE)

(72) Inventors: Serge TAVERNIER, Antwerpen (BE); Jef WENS, Antwerpen (BE); Yorick CLAUWERS, Antwerpen (BE); Steve HELFENSTEYN, Antwerpen (BE); Fabian JANSSENS, Antwerpen (BE)

(73) Assignees: EUROCHEM ANTWERPEN, Antwerpen (BE); UNIVERSITEIT ANTWERPEN, Antwerpen (BE)

(21) Appl. No.: 18/706,855

(22) PCT Filed: Nov. 27, 2022
(86) PCT No.: PCT/EP2022/083381

§ 371 Date: May 2, 2024

(30) Foreign Application Priority Data
Dec. 7, 2021 (BE) 2021/5950

(51) Int. Cl. C05G 3/30; C05G 5/30

(52) U.S. Cl. CPC C05G 3/30; C05G 5/30

(57) ABSTRACT

Disclosed is a method for manufacturing anti-caking fertilizer particles (100) comprising an inorganic fertilizer core (102) and a nanoparticle coating (104), wherein the nanoparticle coating (104) is free of binders.

### FIELD OF THE INVENTION

This invention relates to the field of binder-free, biodegradable anti-caking coatings for inorganic fertilizers. Particle-based coatings have already been described:

### Mineral Coatings

WO2015132258A1 to Yara discloses a method for attaching micronutrients in an outer shell of urea-based particles. A liquid concentrated mineral acid with a water content of at most 25 weight % is applied to urea-based particles. A double salt layer at the outer surface of the urea-based particles is formed. A solid mineral base is then applied. However, this document does not disclose how to obtain a mechanically robust coating. Moreover, concentrated acids are complex to use. Moreover, the ionic species formed by the acid-base reaction increases moisture sensitivity and thus the caking tendency.

WO2018211448A1 to Sabic discloses a fertilizer particle coated with a solid acidic particulate material and subsequently with a solid basic particulate material. The solid acidic particulate material are phosphate-based fertilizers, a biostimulant, a calcium lignosulfonate, or a combination thereof. The solid acidic particulate material is a phosphate-based fertilizer selected from a solid particulate SSP, a solid particulate TSP, or a blend of solid particulate SSP and solid particulate TSP. The disclosed process is a multistep process and thus increases manufacturing costs. The inorganic material is not embedded in the surface and thus creates mechanical instability. The ions formed by the acid-base reaction increases the moisture sensitivity and thus also the caking tendency.

WO2014085190A1 to Cytec discloses a coating composition of an aqueous mineral slurry having a dust suppressing amount of a silicate mineral. The coating is used for dust producing fertilizers, such as single or multi-nutrient fertilizers. However, silicates are sensitive to moisture and hence increase caking.

U.S. Pat. No. 4,486,396A to Norsk Hydro describes the optimization of ammonium nitrates for use as explosives by preserving the porosity of the ammonium nitrate to allow hydrocarbon rich material to penetrate within the granules. Ammonium nitrate particles are susceptible to breakdown. This document proposes to stabilize the particles through a coating with 0.05-1 w % porous SiO2 particles having a surface area of 150-400 m2/g and a pore size of 100-300 Angstrom.

WO2019098853A1 to Elkem Materials discloses a combined NPK-Si fertilizer comprising a mineral NPK fertilizer and particulate amorphous silicon dioxide. The ratio of the mineral NPK fertilizer to the amorphous silicon dioxide is from 10:90 to 90:10. The amount of SiO2 is high which increases costs.

WO2015026806A1 to Mosaic discloses a method for conditioning of granular fertilizers post-manufacture to reduce the generation of dust during handling, transport, and storage of the fertilizers. An aqueous conditioning agent is sprayed to a plurality of fertilizer granules with or without beneficial agricultural and/or dedusting additives. The conditioned fertilizer granules are then optionally heated to temperature from about 50° F. to about 250° F. Then, the added moisture is removed from the aqueous conditioning agent until a final moisture content of the granules is about 0 wt % to about 6.5 wt % of the granules. However, this document does not disclose the use of nanoparticles as binder-free anticaking coatings for nitrogen fertilizers.

### Technical Problem

Therefore, there remains a need for an anti-caking coating that is biodegradable, sustainable, involving low manufacturing costs, being easy to manufacture and stable against moisture and mechanical forces through transport, processing and storage.

### SHORT DESCRIPTION OF THE INVENTION

The inventors have surprisingly found that nanoparticles can be used to coat inorganic fertilizers, in particular nitrogen-containing fertilizers. The nanoparticle coating (104) may be cost-efficiently obtained by moisturizing the fertilizer cores (102) with water, adding nanoparticles (106) to the moisturized fertilizer cores (102) whilst mixing and heating. The coated particles obtained by the method of the present invention (100) surprisingly deliver comparable anti-caking values as do reference polymeric coatings.

A small amount of nanoparticles is already performing. The nanoparticles are well embedded on the surface of the fertilizer cores and have a good surface coverage through mechanical impaction during the coating process.

Accordingly, a first aspect of the invention are anti-caking fertilizer particles (100) comprising an inorganic fertilizer core (102) and a nanoparticle coating (104), obtained by a method comprising the steps of:
a) adding water or an aqueous solvent to the inorganic fertilizer core (102) to obtain a moistened surface;
b) adding nanoparticles (106) on the moistened surface of step (a),
c) mixing, agitating or rotating the mixture of step b) to evenly distribute the nanoparticles on the softened surface;
d) optionally repeating the steps b) to c); and
e) heating the inorganic fertilizer cores (102) to a temperature of 80° C. to 120° C. to obtain a nanoparticle coating (104);

wherein the nanoparticle coating (104) is free of binders.

A further aspect of the invention is a method for manufacturing anti-caking fertilizer particles (100) comprising an inorganic fertilizer core (102) and a nanoparticle coating (104), comprising the steps of:
a) adding water or an aqueous solvent to the inorganic fertilizer core (102) to obtain a moistened surface;
b) adding nanoparticles (106) on the moistened surface of step (a),
c) mixing, agitating or rotating the mixture of step b) to evenly distribute the nanoparticles on the softened surface;
d) optionally repeating the steps b) to c); and
e) heating the inorganic fertilizer cores (102) to a temperature of 80° C. to 120° C. to obtain a nanoparticle coating (104);

wherein the nanoparticle coating (104) is free of binders.

In another aspect, the nanoparticle coating (104) is free of binders selected from the group consisting of polymers, waxes or oils.

In another aspect, the inorganic fertilizer cores (102) comprise nitrogen, phosphorus, potassium or combinations thereof.

In another aspect, steps a) to c) are repeated once, preferably twice.

In another aspect, the water or an aqueous solvent is added in amount of 0.1 to 1 m % as compared to the mass for the inorganic fertilizer core (102).

In another aspect, the nanoparticles are selected from SiO2, Al2O3, C, SiC or mixtures thereof. Preferably, the nanoparticles are SiO2 nanoparticles.

In another aspect, the nanoparticles (106) are present in an amount from 0.1 m % or more, preferably, 0.2 m % or more and even more preferably from 0.3 m % or more as compared to the total mass of the anti-caking fertilizer particles (100).

In another embodiment, the aqueous solvent is added in amount of 0.1 to 2 m % as compared to the mass for the inorganic fertilizer core (102), more preferably 0.2 to 1 m %.

In another aspect, the nanoparticles (106) are present in an amount from 2 m % or less, preferably from 1 m % or less, preferably, 0.7 m % or less and even more preferably from 0.5 m % or less as compared to the total mass of the anti-caking fertilizer particles (100).

In another aspect, the nanoparticles (106) are applied to the inorganic fertilizer core (102) in an amount from 0.1 kg/t to 10 kg/t, preferably from 0.5 kg/t to 5 kg/t, even more preferably from 1 kg/t to 3 kg/t of the inorganic fertilizer core (102).

In another aspect, the specific surface area weight of the nanoparticles (106) is 50 m2/g or more, preferably 70 m2/g or more, even more preferably 100 m2/g.

In another aspect, the specific surface area weight of the nanoparticles (106) is 300 m2/g or less, preferably 250 m2/g or less, even more preferably 200 m2/g/g or less.

In another aspect, the nanoparticles (106) have a primary particle size of smaller than 5 microns, preferably of smaller than 1 microns and even more preferably of smaller than 0.5 microns, even more preferably of smaller than 0.1 microns, even more preferably of smaller than 0.01 microns.

In another aspect, the nanoparticles (106) have a primary particle size of 5 nm to 25 nm, preferably from 10 nm to 20 nm.

In another aspect, a lubricant is added to the anti-caking fertilizer particles (100) to stabilize the anti-caking efficiency after the cooling.

In another aspect, the lubricant is added in an amount of 0.01 kg/t to 1 kg/t of the inorganic fertilizer cores (102), preferably, from 0.1 kg/t to 0.3 kg/t.

In another aspect, the lubricant is magnesium stearate.

A further aspect of the invention, are the anti-caking fertilizer particles (100) obtained by the method of the present invention.

A further aspect are anti-caking fertilizer particles (100) comprising an inorganic fertilizer core (102) and a nanoparticle coating (104), obtained by a method comprising the steps of:
f) adding water or an aqueous solvent to the inorganic fertilizer core (102) to obtain a moistened surface;
g) adding nanoparticles (106) on the moistened surface of step (a),
h) mixing, agitating or rotating the mixture of step b) to evenly distribute the nanoparticles on the softened surface;
i) optionally repeating the steps b) to c); and
j) heating the inorganic fertilizer cores (102) to a temperature of 80° C. to 120° C. to obtain a nanoparticle coating (104);

wherein the nanoparticle coating (104) is free of binders.

### SHORT DESCRIPTION OF THE DRAWINGS

FIG. 1 is a schematic representation of the anti-caking fertilizer particles (100), comprising an inorganic fertilizer core (102) and a binder-free nanoparticle coating (104).

FIG. 2 is a schematic representation of the method of the present invention.

### DETAILED DESCRIPTION OF THE INVENTION

### Fertilizer Core (102)

The inorganic fertilizer core (2) typically is a nitrogen-containing fertilizer, such as straight nitrogen fertilizer cores, but may also comprise other macronutrients such as phosphorus or potassium. A preferred fertilizer core is an NPK fertilizer. Typically, the fertilizer cores (102) are spherical but may also have different shapes depending on their manufacturing process and their storage. The maximum diameter of the fertilizer core (102) preferably is from 1 mm to 5 mm, even more preferably from 2 mm to 4 mm.

### Nanoparticles

The nanoparticles forming the nanoparticle coating (105) may be chosen of any suitable material, such as SiO2, Al2O3. Preferably, the nanoparticles are non-crystalline. SiO2 is a preferred material of nanoparticles.

In one embodiment, the nanoparticles (106) are amorphous silica nanoparticles (CAS-No. 68611-44-9) having a specific surface are weight (BET) from 90 to 130 m2/g. The silica nanoparticles preferably have a pH value in a 4% dispersion of 3 to 6. The nanoparticles (106) preferably have a SiO2 content of 95 m % or more, even more preferably of 98 m % or more, even more preferably of 99 m % or more. The nanoparticles (106) preferably are fumed silica after-treated with dimethyldiclorosilane (DDS). An example of suitable silica nanoparticles is the hydrophobic fumed silica commercially available under the brand Aerosil® R972 from Evonik.

In another embodiment, the silica nanoparticles are hydrophilic fumed silica nanoparticles (CAS-No. 112945-52-5, 7631-86-9). In this embodiment, the specific surface area preferably is from 175 m2/g to 225 m2/g. An example of suitable nanoparticles (106) are commercially available under the brand Aerosil® 200 from Evonik.

In another aspect, the nanoparticles (106) have a primary particle size of smaller than 5 microns, preferably of smaller than 1 microns and even more preferably of smaller than 0.5 microns, even more preferably of smaller than 0.1 microns, even more preferably of smaller than 0.01 microns.

In another aspect, the nanoparticles (106) have a primary particle size of 5 nm to 25 nm, preferably from 10 nm to 20 nm.

In one embodiment, the primary size of the nanoparticles is obtained from the specific surface area (BET) by the following formula:

$$Dp = 6 / r . SSA$$

Where Dp is the primary particle diameter, SSA is the specific surface area of the nanoparticles determined by BET, r is the specific gravity of the nanoparticle material. The specific surface area is preferably determined by BET using N2 adsorption, according to DIN ISO 9277. “Determination of the specific surface area of solids by gas adsorption using the BET method. German Institute of Normalization (DIN); 1995. p. 1-19”.

The nanoparticles (106) may be hydrophilic or hydrophobic.

### Free of Polymer, Wax or Oil

The nanoparticle coating (104) preferably is free of polymers, wax or oil. This is particularly important as the nanoparticle coating (104) thus can replace existing polymeric coatings for regulatory requirements in respect of biodegradability and the avoidance of microplastics contamination of soil through fertilizer use.

In some embodiments, the nanoparticle coating (104) may have minor amounts of other components, such as lubricants, polymers, was or oil. These components are preferably present in amount of 30 m % or less, 20 m % or less, 10 m % or less, 5 m % or less, even more preferably of 3 m % or less and even more preferably of 1 m % or less of the dry mass of the nanoparticle coating or of the anti-caking fertilizer particles (100).

### Lubricants

Preferred lubricants are powdered inorganic particles such as magnesium stearate or zinc stearate which may be added to further reduce the caking of the anti-caking fertilizer particles (100).

In another aspect, a lubricant (108) is added to the anti-caking fertilizer particles (100) to stabilize the anti-caking efficiency. Preferably, the lubricant is added after the cooling of the anti-caking fertilizer particles (100).

### Water or Aqueous Solvent

Water or the aqueous solvent are used to condition the inorganic fertilizer cores (102) and facilitate the adhesion of the nanoparticles on the softened surface. Water is preferred, however, other components may be present in the aqueous solvent.

In a preferred embodiment, the nanoparticulate coating (104) consists of silica nanoparticles (106).

In another embodiment, other components are present in the silica nanoparticulate coating (104) in an amount of from 0.001 to 5 w %, preferably, 0.01 to 2 w %, preferably from 0.01 to 1 w %, even more preferable from 0.01 to 0.1 as compared to the total weight of the nanoparticle coating (104).

### Adhesion of the Nanoparticles (106) and Formation of the Nanoparticle Coating (104)

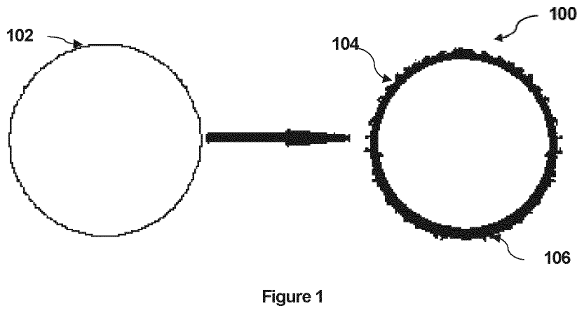

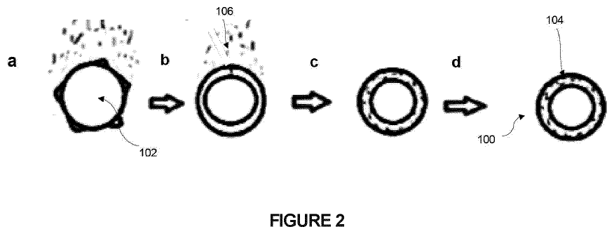

The addition of water for example through spraying as shown in FIG. 2 facilitates the adhesion of the nanoparticles (106) on the softened surface of the fertilizer cores (102). The heating of the moisturized fertilizer cores (102) leads to an expansion and further softening of the outer surface of the moisturized fertilizer cores (102). The nanoparticle coating (104) shown in FIG. 1 is then formed through the application of pressure. Such pressure may be obtained for example through mixing, rotation or other mechanical agitation.

FIG. 2 is a graphic illustration of the method for manufacturing of the anti-caking fertilizer particles (100) comprising an inorganic fertilizer core (102) and a nanoparticle coating (104), wherein the nanoparticle coating (104) is free of binders selected from the group of polymers, waxes or oils, comprising the steps of:
a. adding water or an aqueous solvent to the inorganic fertilizer core (102) to obtain a moistened surface;
b. adding nanoparticles (106) on the moistened surface of step (a),
c. mixing, agitating or rotating the mixture of step b) to evenly distribute the silica nanoparticles on the softened surface;
d. optionally repeating the steps b) to c);
e. heating the inorganic fertilizer cores (102) to a temperature of 80° C. to 120° C. to obtain a nanoparticle coating (104).

### Heating

The heating preferably takes for example 10 to 120 minutes, preferably from 20 to 60 minutes, and even more preferably takes about 30 minutes.

### Intimate Embedding of the Nanoparticles (106) in the Nanoparticle Coating (104)

In one embodiment, the compacting pressure forces the nanoparticles to be strongly embedded in the surface of the fertilizer beads. This ensures the mechanical stability of the coating. The quality of the coating can be assessed by XRF measurements on the coated fertilizer cores before and after attrition.

### Advantages

Water and silica are universally available and may be cost-efficiently used to provide an effective anti-caking coating (104). The amount of coating, more specifically the amount of nanoparticles is low. This reduces the manufacturing costs. The mechanical stability is high.

The anti-caking fertilizer particles (100) are environmentally friendly since no polymer, wax or oil is needed as a binder.

### Examples

NPK fertilizer cores (15-15-15) with a particle size between 2.5-4 mm were measured with respect to caking as an uncoated reference. Fertilizer cores were treated according to the present invention. 250 g of fertilizer cores are added to a rotating coating pan (250 rpm). Water is sprayed onto the fertilizer cores (0.7 g). One third of the amount of fine particles was added and allowed to be mixed for 2 minutes. A new amount of water is sprayed (0.7 g). The second third of the amount of fine particle is added and admixed for 2 minutes. Again, water is sprayed (0.7 g). The final third amount of the fine particles was added and mixed for 2 minutes. The obtained mix was mixed for 15 minutes.

The mixture was heated with hot air (250-300° C.) to 100° C. This heating step typically takes 5-10 minutes. The temperature was monitored by an infrared thermometer.

The heating was stopped after 10 minutes and the mixture was allowed to cool down to 40° C. This typically took 10-15 minutes. All actions were performed while rotating at 250 rpm. The coated granules are then removed from the equipment and allowed to cool to room temperature. An equilibration period of at least 3 days was applied before the caking of said coated granules was measured.

A not biobased coated granule (PE-wax based) is also taken as reference.

A further reference was made by subjecting the granule to similar agitation and temperature treatment but without the addition of the nanoparticles (106),

In case an external lubricating agent was added, the (coated) granules were treated at room temperature by adding the lubricating agent to the agitated granules in the pan for 30 minutes.

The amount of coating is expressed in kg coating per ton of fertilizer core (102). The coating composition is expressed in % w/w. Following ingredients were used:
hydrophilic amorphous silica, 200 m2/g, primary particle size 12 nm commercially available under the brand Aerosil® 200 from Evonik;
hydrophobic amorphous silica, 90-130 m2/g, primary particle size 16 nm; and
Zn-stearate hydrophobic lubricating powder, melting point 120° C.-130° C.

### Loading of SiO2 Nanoparticles in Fertilizer Surface

XRF measurements were done on the A200 coated fertilizer particles. The particles were coated according to the procedure mentioned above. Conditions for the XRF-measurements that were applied are, low Za, Si-signal at 1.77 keV. Uncoated fertilizer cores and a crushed coated fertilizer cores with 5 kg/t of Sio2 served as comparative examples. A tape saturated with SiO2 was taken for 100% coverage, the results recalculated taking into account close sphere packing for the beads. Results are shown in Table 1. From this table it can be seen that the nanoparticles are present at the surface, since crushed samples show a markedly lower Si signal. 3 kg/t already gives a fair surface abundance. Only minor improvement in surface abundance is noticed from 10 kg/t to higher. It has to be noted that starting from 20 kg/t the incorporation of SiO2 is difficult due to problems in handling these amounts of the fluffy material in an easy way.

### Mechanical Stability of the Coating

The mechanical stability of the coating is measured by comparing this signal of coated fertilizer cores with the signal arising from the same cores after mechanical attrition by mechanical impaction and removal of the any detached surface material by a strong air stream. Results are given in table 1. No decrease in Si signal is observed after attrition.

TABLE 1
surface abundance of SiO2 particles and mechanical
stability of the SiO2 coating layer on coated fertilizer
beads as revealed by XRF measurements.

| A200 | Si |
|---|---|
| kg/t | (counts) |
| 0 | 872 |
| 3 | 3109 |
| 5 | 3412 |
| 10 | 3796 |
| 20 | 4258 |
| 40 | 4541 |
| 1000* | 5772 |
| Crushed 5 | 1502 |
| Attrited 5 | 3864 |

### Anti-Caking Performance of (Coated) Fertilizer Particles

The anti-caking property is measured by following method:

160 gr of fertilizer beads (=fertilizer cores (102)) are conditioned for at least 3 days at ambient conditions: room temperature and RH between 40-50%. A metal cylinder (heat jacket) with internal diameter 6.0 cm and height 10.0 cm is filled with three metal rings with an external diameter 5.8 cm, internal diameter 5.5 cm and height 3.0 cm. The conditioned beads are loaded within the space confined by the two bottom metal rings and subjected to a load of 10 kg for 24 hours at 40° C. After compression the outer cylinder is removed carefully in order not to break the compacted assembly of beads confined within the two metal rings. The assembly, i.e. the two rings containing the compacted beads, is subjected to a lateral force by a claw to the top ring, the bottom ring being fixed firmly so that it cannot move. The force to break the two metal rings and internal compacted granular bed apart (expressed in lateral kg-force) is recorded as caking (strength) value. Results are given in Table 2. Comparatives are given. From Table 2 is it clear that the coating of the present invention gives good anti-caking performance, at low nanoparticle loading and this without the use of any binder. The comparative example with PE-wax is not biodegradable, not biobased nor renewable. Consequently, the present invention offers a new type of fertilizer for a more sustainable future.

TABLE 2
Anti-caking performance

| | | SiO2 | Mg-stearate | Caking |
|---|---|---|---|---|
| Example | Coating type | kg/t | kg/t | kg |
| 1.1 comparative | uncoated | — | — | 52 |
| 1.2 comparative | PE-wax | — | — | 17 |
| 1.3 invention | A200 | 5 | — | 16 |
| 1.4 invention | A200/MgSt | 5 | 0.1 | 17 |
| 1.5 invention | A200 + R972 | 2.5 + 2.5 | — | 10 |
| 1.6 invention | A200 + R972/ | 2.5 + 2.5 | 0.1 | 7 |
| | MgSt | | | |

1. Anti-caking fertilizer particles comprising an inorganic fertilizer core and a nanoparticle coating, obtained by a method comprising the steps of:
a) adding water or an aqueous solvent to the inorganic fertilizer core to obtain a moistened surface;
b) adding nanoparticles on the moistened surface of step (a),
c) mixing, agitating or rotating the mixture of step b) to evenly distribute the nanoparticles on the softened surface;
d) optionally repeating the steps b) to c); and
e) heating the inorganic fertilizer cores to a temperature of 80° C. to 120° C. to obtain a nanoparticle coating;
wherein the nanoparticle coating is free of binders.

2. The anti-caking fertilizer particles of claim 1, wherein the nanoparticle coating is free of binders selected from the group consisting of polymers, waxes or oils.

3. The anti-caking fertilizer particles of claim 1, wherein the inorganic fertilizer core comprises nitrogen, phosphorus, potassium or combinations thereof.

4. The anti-caking fertilizer particles of claim 1, wherein steps b) to c) of claim 1 are repeated once, preferably twice.

5. The anti-caking fertilizer particles of claim 1, wherein the nanoparticles are selected from SiO2, Al2O3, C, SiC or combinations thereof.

6. The anti-caking fertilizer particles of claim 1, wherein the nanoparticles are present in an amount from 0.1 m % or more, preferably, 0.21 m % or more and even more preferably from 0.3 m % or more as compared to the total mass of the anti-caking fertilizer particles.

7. The anti-caking fertilizer particles of claim 1, wherein the nanoparticles are present in an amount from 2 m % or less, preferably, 1 m % or less and even more preferably from 0.5 m % or less as compared to the total mass of the anti-caking fertilizer particles.

8. The anti-caking fertilizer particles of claim 1, wherein the nanoparticles are present in an amount from 2 m % or less, preferably from 1 m % or less, preferably from 0.7 m % or less and even more preferably from 0.5 m % or less as compared to the total mass of the anti-caking fertilizer particles.

9. The anti-caking fertilizer particles of claim 1, wherein the specific surface area weight of the nanoparticles is 50 m2/g or more, preferably 70 m2/g or more, even more preferably 100 m2/g or more.

10. The anti-caking fertilizer particles of claim 1, wherein the specific surface area weight of the nanoparticles is 300 m2/g or less, preferably 250 m2/g or less, even more preferably 200 m2/g.

11. The anti-caking fertilizer particles of claim 1, wherein the nanoparticles have a primary particle size of smaller than 5 microns, preferably of smaller than 1 microns and even more preferably of smaller than 0.5 microns, even more preferably of smaller than 0.1 micron.

12. The anti-caking fertilizer particles of claim 1, wherein the nanoparticles have a primary particle size of 5 nm to 25 nm, preferably from 10 nm to 20 nm.

13. The anti-caking fertilizer particles of claim 1, wherein a lubricant is added to the anti-caking fertilizer particles to stabilize the anti-caking efficiency after the cooling.

14. The anti-caking fertilizer particles of claim 1, wherein the lubricant is added in an amount of 0.001 kg/t to 1 kg/t of the inorganic fertilizer cores, preferably, from 0.1 kg/t to 0.3 kg/t.

15. A method for manufacturing anti-caking fertilizer particles comprising an inorganic fertilizer core and a nanoparticle coating, comprising the steps of:
a) adding water or an aqueous solvent to the inorganic fertilizer core to obtain a moistened surface;
b) adding nanoparticles on the moistened surface of step (a),
c) mixing, agitating or rotating the mixture of step b) to evenly distribute the nanoparticles on the softened surface;
d) optionally repeating the steps b) to c); and
e) heating the inorganic fertilizer core to a temperature of 80° C. to 120° C. to obtain a nanoparticle coating;
wherein the nanoparticle coating is free of binders.
